(19) United States
(12) Patent Application Publication
(10) Pub. No.: US 2004/0034865 A1
(43) Pub. Date: Feb. 19, 2004

(54) Program guide for previous program broadcasts

(76) Inventors: Peter T. Barrett, San Francisco, CA (US); James A. Baldwin, Redwood City, CA (US)

Correspondence Address: LEE & HAYES PLLC, 421 W RIVERSIDE AVENUE SUITE 500, SPOKANE, WA, 99201

(21) Appl. No.: 10/218,683

(22) Filed: Aug. 13, 2002

(51) Int. Cl. H04N 5/445; G06F 3/00

(52) U.S. Cl. 725/39

(57) ABSTRACT

A program guide includes a program time display that corresponds to when a program will be broadcast for viewing, and includes a program channel display that corresponds to the program and to the program time display. The program time display and the program channel display are also viewable after the program has been broadcast for viewing. The program guide also includes a selectable control that initiates a request to receive the program for viewing after the program has been previously broadcast.

### TECHNICAL FIELD

This invention relates to television-based systems and, in particular, to a program guide for previous program broadcasts.

### BACKGROUND

A client device in a television-based system, such as a set-top box, a digital video recorder, or a personal video recorder, can receive video content in the form of broadcast television programs. Broadcast television programs include news shows, sitcoms, movies, commercials, and any other form of television-based entertainment and information. A digital or personal video recorder includes a hard disk memory so that a viewer can record some programs of interest to the viewer. However, the hard disk memory in a digital or personal video recorder has limited space to store requested or determined programs for future reference by a viewer. Further, low-resource client devices do not include a hard disk memory to record programs while they are being transmitted from a program distributor to the client devices.

If a viewer has a low-resource client device and/or does not designate a particular program to record for future reference with a digital video recorder, the viewer will not be able to watch the program at any time other than the date and time when the program is scheduled for broadcast. If a viewer misses the scheduled broadcast of the particular program, the viewer will not be able to request an additional broadcast of the previously shown program. One solution is for a program distributor to record and store all of the program broadcasts so that a viewer can later request a particular program that the viewer did not watch and/or record with a client device. A problem with recording all of the program broadcasts at a point of distribution, however, is how to organize and make available the many programs so that a viewer can locate and request a previously broadcast program.

Accordingly, for television-based entertainment and information systems that record and store all previous program broadcasts, there is a need for an intuitive interface that organizes the recorded program broadcasts so that a viewer can determine when a particular program was previously broadcast, and from which the viewer can request the program for viewing.

### SUMMARY

In an implementation, a program guide includes a program time display that corresponds to when a program will be broadcast for viewing, and includes a program channel display that corresponds to the program and to the program time display. The program time display and the program channel display are also viewable after the program has been broadcast for viewing. The program guide also includes a selectable control that initiates a request to receive the program for viewing after the program has been previously broadcast.

In one implementation, a client device in a television-based system includes a program guide that displays schedule information to indicate when programs will be broadcast for viewing. The schedule information can include a time of day when the program will be broadcast, and a program channel over which the program will be broadcast. The program guide also displays the schedule information after the programs have been broadcast for viewing. The client device includes a selectable control to initiate a request to receive a program for viewing after the program has been previously broadcast.

### BRIEF DESCRIPTION OF THE DRAWINGS

The same numbers are used throughout the drawings to reference like features and components.

FIG. 1 illustrates various components of an exemplary system to implement a program guide for previous program broadcasts.

FIG. 2 is a flow diagram that illustrates a method for a program guide for previous program broadcasts.

FIG. 3 illustrates various components of an exemplary client device implemented in a television-based system.

FIG. 4 illustrates an exemplary broadcast video distribution architecture in which a program guide for previous program broadcasts can be implemented.

FIG. 5 further illustrates components of the exemplary broadcast video distribution architecture shown in FIG. 4.

FIG. 6 illustrates an exemplary system architecture in which a program guide for previous program broadcasts can be implemented.

### DETAILED DESCRIPTION

A program guide for previous program broadcasts is described in one implementation as an intuitive interface from which a viewer can determine when a particular program was previously broadcast, and from which the viewer can request the program for viewing. The program guide displays schedule information that corresponds to when programs will be broadcast for viewing, and continues to display the schedule information after the programs have been broadcast for viewing. The program guide also includes a selectable control that, when selected by a viewer, initiates a request to receive a previously broadcast program that has been recorded in a program data store.

Although programs that have been previously broadcast and that are recorded in a program data store are not defined in a conventional manner by a program broadcast time and a corresponding program channel (i.e., a broadcast time and program channel are irrelevant after the program has been recorded), the program guide described herein displays previous program schedule information, such as a program time display and a program channel display, on or after the current date and/or after the current time to indicate when and on which channel a program was broadcast for viewing. If a viewer has missed watching a program, yet commonly knows that the program is on (i.e., broadcast) at a particular time on a particular channel, the viewer will be able to easily find and request the program for viewing.

The following discussion is directed to television-based entertainment and information systems, such as a two-way unicast network, interactive television networks, cable networks that utilize electronic program guides, and Web-enabled television networks. Client devices in such systems range from full-resource clients with substantial memory and processing resources, such as television-enabled personal computers and television recorders equipped with hard-disks, to low-resource clients with limited memory and/or processing resources, such as traditional set-top boxes. While aspects of the described systems and methods can be used in any of these systems and for any types of client devices, they are described in the context of the following exemplary environment.

Exemplary Program Guide System

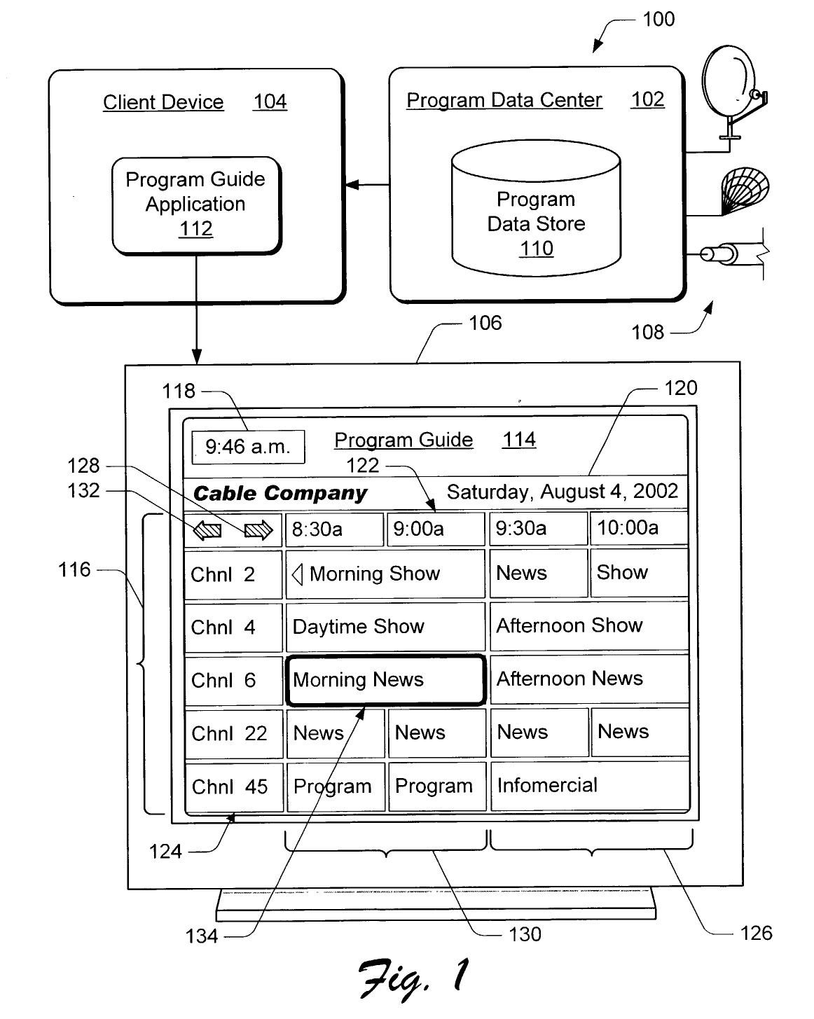

FIG. 1 illustrates various components of an exemplary program guide system 100 to implement a program guide for previous program broadcasts. System 100 includes a program data center 102, a client device 104, and a display device 106. The program data center 102 can be implemented as a headend in a television-based content distribution system, for example, that provides program guide data and broadcast content to multiple client devices. Program data center 102 receives broadcast content via various transmission media 108, such as satellite transmission, radio frequency transmission, cable transmission, and/or via any number of other transmission media.

Program data center 102 receives programs as broadcast content and stores the programs in a program data store 110. The broadcast content can be stored, or otherwise recorded, while the broadcast content is in a compressed format, for example, in order to facilitate the ongoing storage of programs over days, weeks, or even indefinitely. As used herein, “programs” include news shows, sitcoms, comedies, movies, commercials, talk shows, sporting events, and any other form of television-based entertainment and information. Although not shown, program data center 102 includes components to receive requests for recorded programs and control distribution of the recorded programs to client device 104.

Client device 104 can be implemented in any number of embodiments, such as a set-top box, a digital video recorder (DVR) and playback system, and any other type of television-based client device. Client device 104 includes a program guide application 112 that generates a program guide 114 shown on display device 106. Program guide application 112 generates program guide 114 with the program guide data received from program data center 102. The on-screen program guide 114 enables a television viewer to navigate through a program grid 116 and locate programs of interest to the viewer.

Program guide 114 includes a current time display 118, a current date display 120, and schedule information to indicate when a particular program will be broadcast for viewing and on which channel the program will be broadcast. The program grid 116 includes program time displays 122, where a particular program time display indicates a time of day when a program will be broadcast for viewing. The program grid 116 also includes program channel displays 124, where a particular program channel display corresponds to a program time display and indicates a program channel over which a program will be broadcast for viewing. For example, a “Local News” program will be broadcast for viewing at 9:30 a.m. on program channel four (4).

Program grid 116 includes a first section 126 that displays schedule information to indicate when programs will be broadcast for viewing. In this example, the current time 118 is 9:46 a.m., and the first section 126 identifies programs that are currently being broadcast for viewing, or will be broadcast for viewing. For example, the “Local News” program started at 9:30 a.m. and is currently being broadcast. Another “News” program will begin broadcast for viewing at 10:00 a.m. on program channel twenty-two (22). Program guide 114 includes a selectable control 128 that, when selected, scrolls the program guide 114 ahead in time and/or ahead in days to provide a viewer with schedule information for future program broadcasts.

Program grid 116 also includes a second section 130 that displays schedule information to indicate programs that have been previously broadcast for viewing. The previously broadcast programs are recorded and available upon request from the program data store 110 at the program data center 102. In this example, the second section 130 of program grid 116 identifies a “Daytime Show” program that was broadcast for viewing from 8:30 a.m. to 9:30 a.m. Although the current time 118 is 9:46 a.m., the second section 130 of program grid 116 provides a viewer with schedule information for previous program broadcasts. Program guide 114 includes a selectable control 132 that, when selected, scrolls the program guide 114 back in time and/or back in days to display previous programs and schedule information.

Program guide 114 includes a selectable control 134 shown implemented as an on-screen focus that can be positioned to identify a program and, when selected, initiate that client device 104 request the selected program from the program data center 102 for viewing after the program has been previously broadcast. For example, selectable control 134 is positioned in the second section 130 of program grid 116 to identify a “Morning News” program that was broadcast for viewing from 8:30 a.m. to 9:30 a.m. on program channel six (6). A viewer can select the program and initiate a request to receive a broadcast or transmission of the program which has been recorded in program data store 110 at the program data center 102. The previously broadcast program has been recorded in program data store 110 because, in this example, the program was broadcast for viewing from 8:30 a.m. to 9:30 a.m. and the current time 118 is 9:46 a.m.

When selectable control 134 is positioned to identify a program in the first section 126 of program grid 116, a viewer can select to view the program if it is currently being broadcast, access program data to learn more about the program, and/or enter a request to record one or more episodes of the program. A viewer can move selectable control 134 within the program grid 116 by manipulating an input device, such as a remote control for example.

Although programs that have been previously broadcast and that are recorded at the program data center 102 are no longer defined in a conventional manner by a program broadcast time and corresponding program channel, program guide 114 provides an intuitive interface with the program schedule information from which a viewer can determine when a particular program was previously broadcast, and from which the viewer can request the program for viewing. In program guide 114, the program schedule information, such as a program time display and a program channel display, are viewable on or after the current date and/or after the current time to indicate when and on which channel the program was broadcast for viewing. If a viewer has missed watching a program, yet commonly knows that the program is on (i.e., broadcast) at a particular time on a particular channel, the viewer will be able to easily find and request the program for viewing.

Methods for a Program Guide for Previous Program Broadcasts

Methods for a program guide for previous program broadcasts may be described in the general context of computer-executable instructions. Generally, computer-executable instructions include routines, programs, objects, components, data structures, and the like that perform particular functions or implement particular abstract data types. The described methods may also be practiced in distributed computing environments where functions are performed by remote processing devices that are linked through a communications network. In a distributed computing environment, computer-executable instructions may be located in both local and remote computer storage media, including memory storage devices.

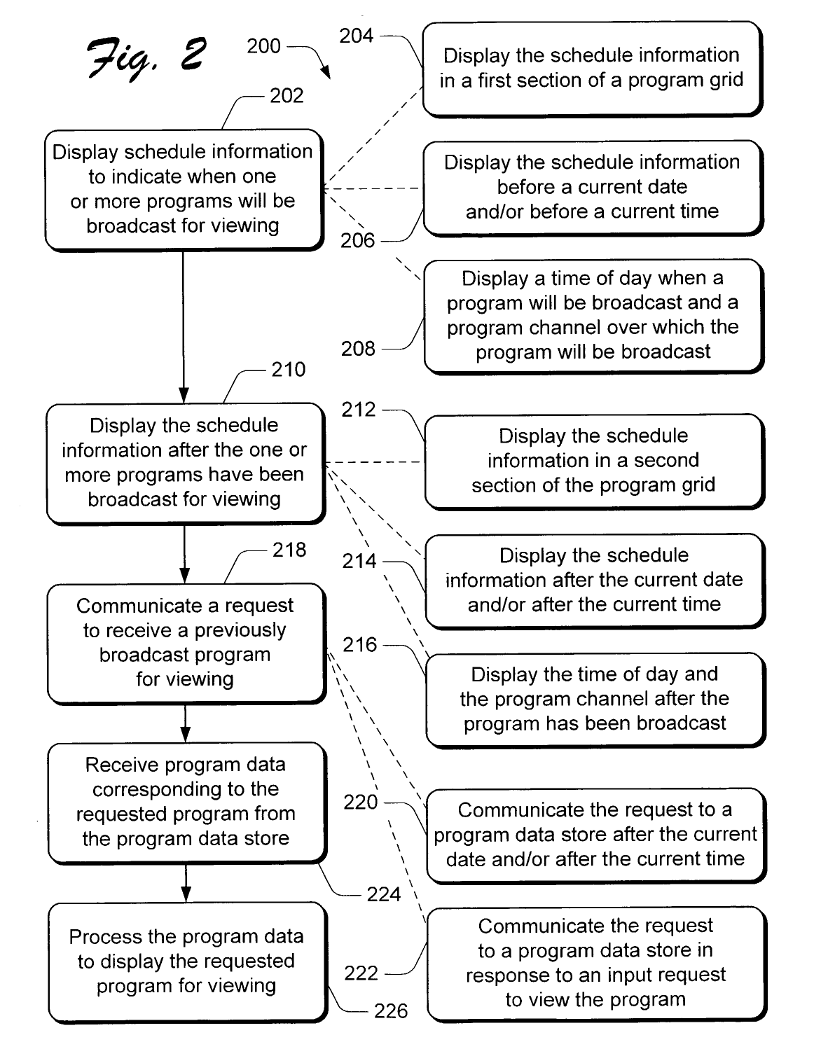

FIG. 2 illustrates a method 200 for a program guide for previous program broadcasts. The order in which the method is described is not intended to be construed as a limitation, and any number of the described method blocks can be combined in any order to implement the method. Furthermore, the method can be implemented in any suitable hardware, software, firmware, or combination thereof.

At block 202, schedule information is displayed to indicate when one or more programs will be broadcast for viewing. Displaying the schedule information can include any one or combination of displaying the schedule information in a first section of a program grid at block 204, displaying the schedule information before a current date and/or before a current time at block 206, and/or displaying a time of day when a particular program will be broadcast for viewing and a program channel over which the program will be broadcast for viewing at block 208. For example, program guide 114 (FIG. 1) has a first section 126 of program grid 116 that displays schedule information, such as a time of day 122 when a particular program will be broadcast for viewing and a program channel 124 over which the program will be broadcast. The schedule information displayed in the first section 126 identifies programs that are currently being broadcast for viewing, or will be broadcast for viewing. Thus, the schedule information is displayed on or before the current date 120 and/or before the current time 118.

At block 210, the schedule information is displayed after the one or more programs have been broadcast for viewing. Displaying the schedule information after the one or more programs have been broadcast can include any one or combination of displaying the schedule information in a second section of the program grid at block 212, displaying the schedule information after the current date and/or after the current time at block 214, and/or displaying the time of day and the program channel after the program has been broadcast for viewing at block 216. For example, program guide 114 (FIG. 1) has a second section 130 of program grid 116 that displays schedule information, such as a time of day 122 and a program channel 124 after a program has been broadcast for viewing. The schedule information displayed in the second section 130 identifies programs that have been previously broadcast for viewing. Thus, the schedule information is displayed on or after the current date 120 and/or after the current time 118.

At block 318, a request to receive a program for viewing is communicated to a program data store after the program has been broadcast for viewing. Communicating the request can include any one or combination of communicating the request to the program data store after the current date and/or after the current time at block 320, and communicating the request to the program data store in response to an input request to view the program at block 322. For example, when selectable control 134 (FIG. 1) is positioned within the program guide 114 to identify a previously broadcast program in the second section 130 of program grid 116, and when a viewer initiates an input request to view the program, the client device 104 communicates the program request to program data center 102 which records previous program broadcasts in the program data store 110.

At block 224, program data corresponding to the requested program is received from the program data store, and at block 226, the program data is processed to display the program for viewing.

Exemplary Client Device in a Television-based System

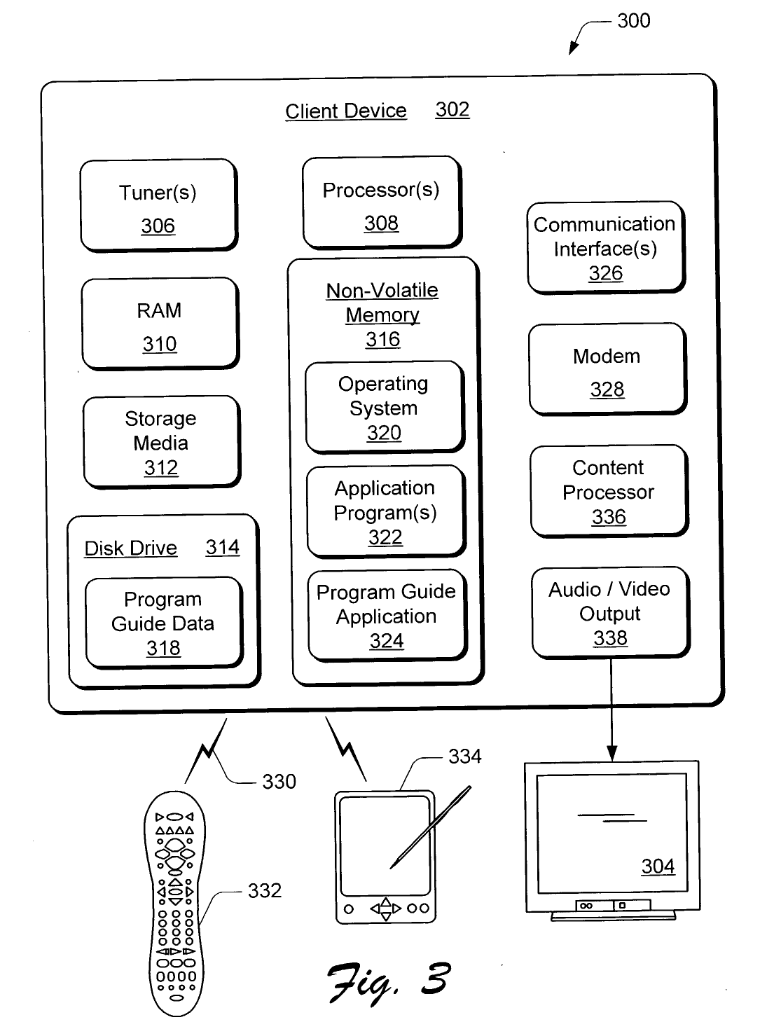

FIG. 3 illustrates a television-based system 300 that includes an exemplary client device 302, such as client device 104 shown in FIG. 1, and also includes a display device 304, such as display device 106 shown in FIG. 1. Client device 302 includes components to implement a program guide for previous program broadcasts and can be implemented as a set-top box, a satellite receiver, a TV recorder with a hard disk, a digital video recorder (DVR) and playback system, a personal video recorder (PVR) and playback system, a game console, an information appliance, and as any number of similar embodiments.

Client device 302 includes one or more tuners 306 which are representative of one or more in-band tuners that tune to various frequencies or channels to receive television signals, as well as an out-of-band tuner that tunes to the broadcast channel over which program data is broadcast to client device 302. Client device 302 also includes one or more processors 308 (e.g., microprocessors) which process various instructions to control the operation of client device 302 and to communicate with other electronic and computing devices.

Client device 302 can be implemented with one or more memory components, examples of which include a random access memory (RAM) 310, mass storage media 312, a disk drive 314, and a non-volatile memory 316 (e.g., ROM, Flash, EPROM, EEPROM, etc.). The one or more memory components store various information and/or data such as received content, program guide data 318, configuration information for client device 302, and/or graphical user interface information.

Alternative implementations of client device 302 can include a range of processing and memory capabilities, and may include any number and different memory components than those illustrated in FIG. 3. For example, full-resource clients can be implemented with substantial memory and processing resources, including the disk drive 314. Low-resource clients, however, may have limited processing and memory capabilities, such as a limited amount of RAM 310 and limited processing capabilities of a processor 308.

An operating system 320 and one or more application programs 322 can be stored in non-volatile memory 316 and executed on a processor 308 to provide a runtime environment. A runtime environment facilitates extensibility of client device 302 by allowing various interfaces to be defined that, in turn, allow application programs 322 to interact with client device 302. The application programs 322 can include a browser to browse the Web (e.g., “World Wide Web”), an email program to facilitate electronic mail, and any number of other application programs.

A program guide application 324 is implemented to process the program guide data 318 and generate a program guide for display, such as program guide 114 shown in FIG. 1 for example. Program guide application 324 utilizes the program guide data 318 and enables a television viewer to navigate through an onscreen program guide and locate programs, video on-demand movies, interactive game selections, and other media access information or content of interest to the viewer. With program guide application 324, the television viewer can look at schedules of past, current, and future programming, set reminders for upcoming programs, and/or enter instructions to record one or more television shows or video on-demand movies.

The program guide application 324 can be implemented as a software component that executes on a processor 308 and is stored in non-volatile memory 316 in client device 302. Although program guide application 324 is illustrated and described as a single application configured to perform several functions of a program guide for previous program broadcasts, the program guide application 324 can be implemented as several component applications distributed to each perform one or more functions in a computing device, a set-top box, a digital video recorder system, a personal video recorder system, and/or any other television-based entertainment and information system.

Client device 302 further includes one or more communication interfaces 326 and a PSTN, DSL, or cable modem 328. A communication interface 326 can be implemented as a serial and/or parallel interface, as a wireless interface, and/or as any other type of network interface. A wireless interface enables client device 302 to receive control input commands 330 and other information from a user-operated input device, such as from a remote control device 332 or from another infrared (IR), 802.11, Bluetooth, or similar RF input device. Input devices can include a wireless keyboard or another handheld input device 334 such as a personal digital assistant (PDA), handheld computer, wireless phone, or the like. A network interface and a serial and/or parallel interface enables client device 302 to interact and communicate with other electronic and computing devices via various communication links. Modem 328 facilitates client device 302 communication with other electronic and computing devices via a conventional telephone line, a DSL connection, or a cable modem.

Client device 302 also includes a content processor 336 which can include a video decoder and/or additional processors to receive, process, and decode broadcast video signals and program data, such as NTSC, PAL, SECAM, or other television system analog video signals, as well as DVB, ATSC, or other television system digital video signals. For example, content processor 336 can include an MPEG-2 or MPEG-4 (Moving Pictures Experts Group) decoder that decodes MPEG-encoded video content. The systems described herein can be implemented for any type of video encoding format as well as for data and/or content streams that are not encoded.

Typically, video content and program data includes video data and corresponding audio data. Content processor 336 generates video and/or display content that is formatted for display on display device 304, and generates decoded audio data that is formatted for broadcast by a broadcast device, such as one or more speakers (not shown) in display device 304. Content processor 336 can include a display controller (not shown) that processes the video and/or display content to display corresponding images on display device 304. A display controller can include a microcontroller, integrated circuit, and/or similar video processing component to process the images.

Client device 302 also includes an audio and/or video output 338 that provides the audio, video, and/or display signals to television 304 or to other devices that process and/or display, or otherwise render, the audio and video data. Video signals and audio signals can be communicated from client device 302 to television 304 via an RF (radio frequency) link, S-video link, composite video link, component video link, or other similar communication link.

Although shown separately, some of the components of client device 302 may be implemented in an application specific integrated circuit (ASIC). Additionally, a system bus (not shown) typically connects the various components within client device 302. A system bus can be implemented as one or more of any of several types of bus structures, including a memory bus or memory controller, a peripheral bus, an accelerated graphics port, or a local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Exemplary System Architectures

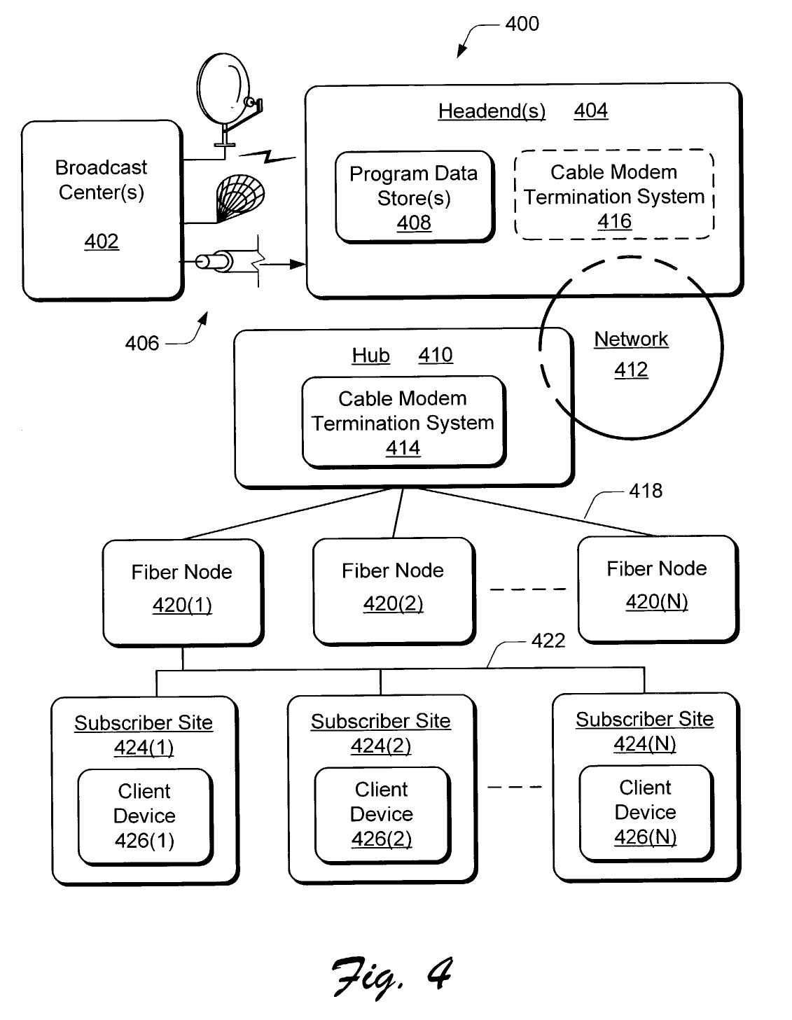

FIG. 4 illustrates an exemplary broadcast video distribution architecture 400 in which a program guide for previous program broadcasts can be implemented. One or more broadcast centers 402 provide broadcast content to one or more headends 404 via one or more transmission media 406. Each broadcast center 402 and headend 404 interfaces with the various transmission media 406, such as a satellite transmission, radio frequency transmission, cable transmission, and/or via any number of other transmission media. A broadcast center 402 can be implemented as a satellite operator, a network television operator, a cable operator, and the like.

A headend 404 includes one or more program data stores 408 to record the broadcast content that is received via a transmission media 406. The broadcast content can be stored, or otherwise recorded, while the broadcast content is in a compressed format, for example, in order to facilitate the ongoing storage of the content over days, weeks, or even indefinitely. The compression format may comport with a Moving Pictures Expert Group (MPEG) algorithm, such as MPEG-2, MPEG-4, and so forth. Other compression technologies may alternatively be employed, such as Microsoft Windows® Media, Advanced Simple Profile (ASP), Cintak, and the like.

A headend 404 and a hub 410 communicate across a network 412 which can be implemented as a fiber ring that may operate with a packet-based protocol, such as Internet protocol (IP), IP over asynchronous transfer mode (ATM), and other protocols. Packets can therefore be communicated between headend 404 and hub 410 which includes a cable modem termination system 414 for terminating communications from downstream cable modems. Alternatively, headend 404 may include a cable modem termination system 416 to terminate the cable modem communications. Although only one hub 410 is illustrated in architecture 400, a headend 404 can distribute broadcast content to multiple hubs 410 via network 412.

Hub 410 distributes the broadcast content over fiber lines 418 to one or more fiber nodes 420(1), 420(2) . . . 420(N). Each fiber node 420 has one or more coaxial lines 422 over which the broadcast content is output, and each coaxial line 422 includes coaxial line drops to multiple subscriber sites 424(1), 424(2), . . . 424(N). Each subscriber site 424 includes one or more client devices 426(1), 426(2), . . . 426(N), respectively. Subscriber sites 424 can be homes, businesses, and the like with each subscriber site 424 including multiple client devices 426 that are each directly or indirectly interfacing with one or more of coaxial lines 422. Client devices 426 may be computers, set-top boxes of varying capabilities, hand-held and/or portable electronic devices, digital televisions, and so forth. Each client device 426 may include an integrated video screen or may be coupled to a video screen.

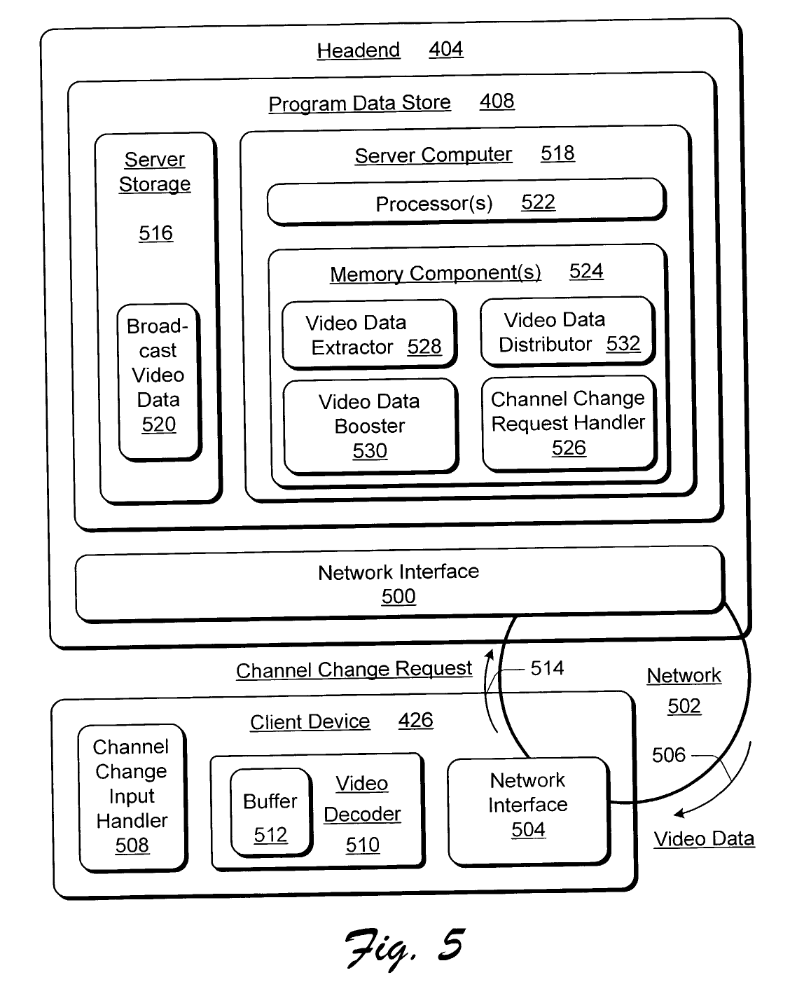

FIG. 5 further illustrates an exemplary headend 404 and an exemplary client device 426 as shown in FIG. 4. Headend 404 includes a network interface 500 to communicate over a network 502, and client device 426 includes a network interface 504 to communicate over the network 502. Network 502 can be any two-way unicast network, such as a unicast network that enables point-to-point Internet protocol (IP) sessions, for example. Alternatively, network 502 can be implemented as a video-on-demand (VOD) type network, as a video over digital subscriber line (DSL)-based network, and the like.

Network 502 may include one or more other nodes that are upstream of client device 426 in addition to headend 404. For example, hub 410 (FIG. 4) and fiber nodes 420 may be located between client device 426 and headend 404 for forwarding and/or routing packets or other communications between the devices. Additionally, network 502 can be implemented as a combination of networks and network interfaces 500 and 504 may vary depending on the architecture of network 502. In an exemplary cable network implementation, network interface 500 includes a cable modem termination system (such as system 416 in FIG. 4) if there is not an intervening cable modem termination system in network 502, and network interface 504 includes a cable modem. Network interface 500 and/or network interface 504 may also include components for interacting with an IP network, a DSL network, and so forth. These components may include a receiver, a transmitter, a transceiver, etc. that are adapted to interact with the appropriate network.

In one exemplary implementation, broadcast content distribution from headend 404 to client device 426 is implemented with a point-to-point IP session that is established between headend 404 and client device 426. Broadcast content, such as video data 506 for a specific channel, is streamed to client device 426 across network 502. Thus, each client device 426 receives its own designated broadcast video data stream according to its corresponding requested channel. Further, each fiber node 420 (FIG. 1), if present, has a different current allocation of a two-way portion of the network that is intended for downstream transmissions to client devices 426.

Client device 426 includes a channel change input handler 508 and a video decoder 510, as well as the network interface 504. Video decoder 510 includes a buffer 512 for storing received broadcast content, such as the video data, prior to decoding. Channel change input handler 508 receives channel change input requests from a user of client device 426. A channel change input request can be received from a remote control, a keyboard, a personal digital assistant (PDA), a touch-sensitive screen, integrated keys, and from any other type of input device.

Channel change input handler 508 can be implemented as executable instructions and/or hardware, software, firmware, or some combination thereof. Channel change input handler 508 constructs a channel change request 514 in packet form that includes an indicator of the requested channel. Channel change request 514 is communicated from channel change input handler 508 to network interface 504 of client device 426 for transmission over network 502.

Network interface 500 of headend 404 receives channel change request 514 via network 502, and provides the channel change request 514 to the program data store 408. Program data store 408 includes a server storage 516 and a server computer 518. Server storage 516 includes a storage device (not explicitly shown) that comprises mass memory storage, such as a disk-based storage device. Examples of suitable disk-based storage devices and/or systems include a redundant array of independent/inexpensive disks (RAID), a Fibre Channel storage device, and the like.

Server storage 516 stores broadcast video data 520 which is broadcast from a broadcast center 402 (FIG. 1) to headend 404 in a compressed format. In an exemplary implementation, the compressed format comprises a digital stream in accordance with an MPEG protocol, such as MPEG-4. However, other compression formats may alternatively be used. As the compressed digital stream is received at headend 404, it is stored as broadcast video data 520. Server storage 516 can maintain broadcast video data 520 for multiple channels as it is received over hours, days, weeks, and/or indefinitely.

Server computer 518 enables access to the stored, or otherwise recorded, broadcast video data 520 at server storage 516. Server computer 518 includes one or more processors 522 and one or more memory component(s) 524. Although not shown, server computer 518 may also include other components such as input/output interfaces; a local disk drive; hardware and/or software for encoding, decoding, and otherwise manipulating video data, and so forth. A memory component 524 can be implemented as, or include, a non-volatile memory such as disk drive(s) or flash memory and/or volatile memory such as random access memory (RAM). In an exemplary implementation, a memory component 524 includes electronically-executable instructions.

Specifically, a memory component 524 includes the following electronically-executable instructions: a channel change request handler 526, a video data extractor 528, a video data booster 530, and a video data distributor 532. The electronically-executable instructions of memory component 524 can be executed on a processor 522 to implement functions as described below. In alternative implementations, one or more of channel change request handler 526, video data extractor 528, video data booster 530, and video data distributor 532 may be stored in a memory such that they are hardware encoded for automatic execution and/or for faster execution by a processor 522.

Network interface 500 forwards channel change request 514 to channel change request handler 526 which isolates the requested channel from channel change request 514 and provides the requested channel to video data extractor 528. Video data extractor 528 extracts broadcast video data for the requested channel from broadcast video data 520 of server storage 516. Video data distributor 532 communicates the broadcast video data to network interface 500 which transmits the broadcast video data over network 502 as video data packet(s) 506. Client device 426 receives the video data packet(s) 506 via network 502 at network interface 504.

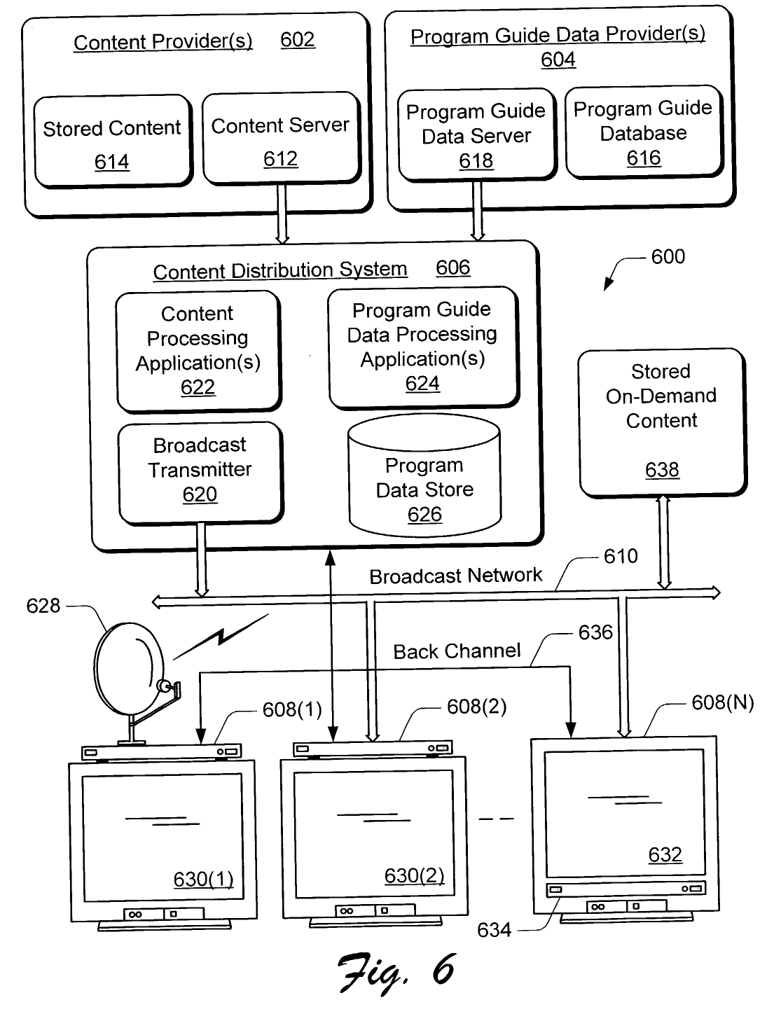

FIG. 6 illustrates an exemplary television entertainment system 600 that is an architecture in which a program guide for previous program broadcasts can be implemented. System 600 facilitates distribution of content and program guide data to multiple viewers. The system 600 includes one or more content providers 602, one or more program guide data providers 604, a content distribution system 606, and multiple client devices 608(1), 608(2), . . . , 608(N) coupled to the content distribution system 606 via a broadcast network 610.

A content provider 602 includes a content server 612 to control distribution of stored content 614, such as movies, television programs, commercials, music, and similar audio and/or video content from content provider 602 to the content distribution system 606. Additionally, content server 612 controls distribution of live content (e.g., content that was not previously stored, such as live feeds) and/or content stored at other locations to the content distribution system 606. A program guide data provider 604 includes a program guide database 616 and a program guide data server 618. The program guide database 616 stores electronic files of program guide data which is used to generate an electronic or interactive program guide (or, “program guide”).

Program guide data can include a program title, program broadcast day(s) to identify which days of the week the program will be broadcast, program start times(s) to identify a time that the program will be broadcast on the particular day or days of the week, and a program category. A program category describes the genre of a program and categorizes it as a particular program type. For example, a program can be categorized as a movie, a comedy, a sporting event, a news program, a sitcom, a talk show, or as any number of other category descriptions. Program guide data can also include program ratings, characters, descriptions, actor names, station identifiers, channel identifiers, schedule information, and any number of other types of program information. Additionally, program guide data may include video on-demand content information, such as movie schedules, as well as application information, such as for interactive games, and other programming information that may be of interest to a viewer.

The program guide data server 618 processes the program guide data prior to distribution to generate a published version of the program guide data which can contain programming information for all broadcast channels and on-demand content listings for one or more days. The processing may involve any number of techniques to reduce, modify, or enhance the program data such as data compression, format modification, and the like. The program guide data server 618 controls distribution of the published version of the program guide data from a program guide data provider 604 to the content distribution system 606 using, for example, a file transfer protocol (FTP) over a TCP/IP network (e.g., Internet or Intranet). Further, the published version of the program guide data can be transmitted from program data provider 604 via a satellite and the content distribution system 606 directly to a client device 608.

Content distribution system 606 is representative of a headend service and/or program data center 102 (FIG. 1) that provides program guide data, as well as content, to multiple subscribers (e.g., client devices 608). Each content distribution system 606 may receive a different version of the program guide data that takes into account different programming preferences and lineups. The program guide data server 618 can create different versions of the program guide data that includes those channels of relevance to respective headend services, and the content distribution system 606 transmits the program guide data to the multiple client devices 608. In one implementation, for example, content distribution system 606 utilizes a carousel file system to repeatedly broadcast the program guide data over an out-of-band (OOB) channel to the client devices 608. Alternatively, the multiple client devices 608 can receive standard, or uniform, program guide data and individually determine which program guide data to display based on the associated headend service.

Content distribution system 606 includes a broadcast transmitter 620, one or more content processing applications 622, one or more program guide data processing applications 624, and a program data store 626 to store, or otherwise record, broadcast programs for future reference. Broadcast transmitter 620 broadcasts signals, such as cable television signals, across broadcast network 610. Broadcast network 610 can include a cable television network, RF, microwave, satellite, and/or data network, such as the Internet, and may also include wired or wireless transmission media using any broadcast format or broadcast protocol. Additionally, broadcast network 610 can be any type of network, using any type of network topology and any network communication protocol, and can be represented or otherwise implemented as a combination of two or more networks.

A content processing application 622 processes the content received from a content provider 602 prior to transmitting the content across broadcast network 610. Similarly, a program guide data processing application 624 processes the program guide data received from a program guide data provider 604 prior to transmitting the program guide data across broadcast network 610. A particular content processing application 622 may encode, or otherwise process, the received content into a format that is understood by the multiple client devices 108 which are coupled to broadcast network 610. Although FIG. 6 shows a single content provider 602, a single program guide data provider 604, and a single content distribution system 606, exemplary system 600 can include any number of content providers and/or program guide data providers coupled to any number of content distribution systems.

Client devices 608 can be implemented in a number of ways. For example, a client device 608(1) receives broadcast content from a satellite-based transmitter via a satellite dish 628. Client device 608(1) is also referred to as a set-top box or a satellite receiving device. Client device 608(1) is coupled to a television 630(1) for presenting the content received by the client device (e.g., audio data and video data), as well as a graphical user interface. A particular client device 608 can be coupled to any number of televisions 630 and/or similar devices that can be implemented to display or otherwise render content. Similarly, any number of client devices 608 can be coupled to a single television 630.

Client device 608(2) is also coupled to receive broadcast content from broadcast network 610 and provide the received content to associated television 630(2). Client device 608(N) is an example of a combination television 632 and integrated set-top box 634. In this example, the various components and functionality of the set-top box are integrated into the television, rather than using two separate devices. The set-top box integrated into the television can receive broadcast signals via a satellite dish (similar to satellite dish 628) and/or via broadcast network 610. In alternate implementations, client devices 608 may receive broadcast signals via the Internet or any other broadcast medium, such as back channel 636 which can be implemented as a Internet protocol (IP) connection or as other protocol connections using a modem connection and conventional telephone line, for example. Further, back channel 636 provides an alternate communication link between each of the client devices 608, and between the client devices 608 and the content distribution system 606.

The exemplary system 100 also includes stored on-demand content 638, such as Video On-Demand (VOD) movie content. The stored on-demand content 638 can be viewed with a television 630 via a client device 608 through an onscreen movie guide, for example, and a viewer can enter instructions to stream a particular movie, or other stored content, to a corresponding client device 608.

Conclusion

Although the invention has been described in language specific to structural features and/or methods, it is to be understood that the invention defined in the appended claims is not necessarily limited to the specific features or methods described. Rather, the specific features and methods are disclosed as preferred forms of implementing the claimed invention.

1. A program guide, comprising:
a program time display corresponding to when a program will be broadcast for viewing;
a program channel display corresponding to the program and to the program time display, wherein the program time display and the program channel display are viewable after the program has been broadcast for viewing; and
a selectable control configured to initiate a request to receive the program for viewing after the program has been previously broadcast.

2. A program guide as recited in claim 1, further comprising a current date display, wherein the program time display and the program channel display are viewable after the current date to indicate when and on which channel the program was broadcast for viewing.

3. A program guide as recited in claim 2, wherein the selectable control is further configured to initiate the request to receive the program from a program data store after the current date.

4. A program guide as recited in claim 1, further comprising a current time display, wherein the program time display and the program channel display are viewable after the current time to indicate when and on which channel the program was broadcast for viewing.

5. A program guide as recited in claim 4, wherein the selectable control is further configured to initiate the request to receive the program from a program data store after the current time.

6. A client device in a television-based system comprising the program guide as recited in claim 1.

7. A program guide, comprising:
a first section of a program grid configured to display schedule information to indicate when one or more programs will be broadcast for viewing;
a second section of the program grid configured to display past schedule information to indicate when one or more previously broadcast programs were broadcast for viewing; and
a selectable control configured to initiate a request to receive a previously broadcast program for viewing.

8. A program guide as recited in claim 7, wherein:
the first section of the program grid is further configured to display a time of day when a program will be broadcast for viewing; and
the second section of the program grid is further configured to display the time of day when the program has been broadcast for viewing.

9. A program guide as recited in claim 7, wherein:
the first section of the program grid is further configured to display a program channel over which a program will be broadcast for viewing; and
the second section of the program grid is further configured to display the program channel over which the program has been broadcast for viewing.

10. A program guide as recited in claim 7, wherein the selectable control is further configured to initiate the request to receive the previously broadcast program from a program data store.

11. A program guide as recited in claim 7, further comprising a current date display, wherein:
the first section of the program grid is further configured to display the schedule information before the current date to indicate when the one or more programs will be broadcast for viewing; and
the second section of the program grid is further configured to display the past schedule information after the current date to indicate when the one or more previously broadcast programs were broadcast for viewing.

12. A program guide as recited in claim 11, wherein the selectable control is further configured to initiate the request to receive the previously broadcast program from a program data store after the current date.

13. A program guide as recited in claim 7, further comprising a current time display, wherein:
the first section of the program grid is further configured to display the schedule information before the current time to indicate when the one or more programs will be broadcast for viewing; and
the second section of the program grid is further configured to display the past schedule information after the current time to indicate when the one or more previously broadcast programs were broadcast for viewing.

14. A program guide as recited in claim 13, wherein the selectable control is further configured to initiate the request to receive the previously broadcast program from a program data store after the current time.

15. A client device in a television-based system comprising the program guide as recited in claim 7.

16. A client device in a television-based system, comprising:
a program guide configured to display schedule information to indicate when one or more programs will be broadcast for viewing, the program guide further configured to display the schedule information after the one or more programs have been broadcast for viewing;
a selectable control configured to initiate a request to receive a program for viewing after the program has been previously broadcast; and
one or more components configured to receive program data corresponding to the program, and further configured to process the program data to display the program.

17. A client device as recited in claim 16, wherein the program guide is further configured to:
display a time of day when the program will be broadcast for viewing; and
display the time of day after the program has been broadcast for viewing.

18. A client device as recited in claim 16, wherein the program guide is further configured to:
display a program channel over which the program will be broadcast for viewing; and
display the program channel after the program has been broadcast for viewing.

19. A client device as recited in claim 16, wherein the selectable control is further configured to initiate the request to receive the program from a program data store, and wherein the one or more components are further configured to receive the program data from the program data store.

20. A client device as recited in claim 16, wherein the program guide is further configured to:
display the schedule information before a current date to indicate when the one or more programs will be broadcast for viewing; and
display the schedule information after the current date to indicate when the one or more programs have been broadcast for viewing.

21. A client device as recited in claim 20, wherein the selectable control is further configured to initiate the request to receive the program from a program data store after the current date.

22. A client device as recited in claim 16, wherein the program guide is further configured to:
display the schedule information before a current time to indicate when the one or more programs will be broadcast for viewing; and
display the schedule information after the current time to indicate when the one or more programs have been broadcast for viewing.

23. A client device as recited in claim 22, wherein the selectable control is further configured to initiate the request to receive the program from a program data store after the current time.

24. A method, comprising:
displaying schedule information to indicate when one or more programs will be broadcast for viewing;
displaying the schedule information after the one or more programs have been broadcast for viewing; and
communicating a request to receive a program for viewing after the program has been broadcast.

25. A method as recited in claim 24, further comprising:
receiving program data corresponding to the program from a program data store; and
processing the program data to display the program.

26. A method as recited in claim 24, wherein displaying the schedule information includes displaying a time of day when the program will be broadcast for viewing, and displaying the time of day after the program has been broadcast for viewing.

27. A method as recited in claim 24, wherein displaying the schedule information includes displaying a program channel over which the program will be broadcast for viewing, and displaying the program channel after the program has been broadcast for viewing.

28. A method as recited in claim 24, wherein displaying the schedule information includes:
displaying a time of day when the program will be broadcast for viewing;
displaying a program channel over which the program will be broadcast for viewing; and
displaying the time of day and the program channel after the program has been broadcast for viewing.

29. A method as recited in claim 24, wherein displaying the schedule information includes:
displaying the schedule information before a current date to indicate when the one or more programs will be broadcast for viewing; and
displaying the schedule information after the current date to indicate when the one or more programs have been broadcast for viewing.

30. A method as recited in claim 29, wherein the request to receive the program is communicated to a program data store after the current date.

31. A method as recited in claim 24, wherein displaying the schedule information includes:
displaying the schedule information before a current time to indicate when the one or more programs will be broadcast for viewing; and
displaying the schedule information after the current time to indicate when the one or more programs have been broadcast for viewing.

32. A method as recited in claim 31, wherein the request to receive the program is communicated to a program data store after the current time.

33. One or more computer-readable media comprising computer-executable instructions that, when executed, direct a client device in a television-based system to perform the method of claim 24.

34. One or more computer-readable media comprising computer-executable instructions that, when executed, direct a client device to:
display schedule information in a program grid, the schedule information indicating when one or more programs will be broadcast for viewing;
display the schedule information in the program grid after the one or more programs have been broadcast for viewing; and
request to receive a program previously broadcast for viewing, the request being communicated to a program data store in response to an input request to view the program.

35. One or more computer-readable media as recited in claim 34, further comprising computer executable instructions that, when executed, direct the client device to display the schedule information in a first section of the program grid before a current date, and direct the client device to display the schedule information in a second section of the program grid after the current date.

36. One or more computer-readable media as recited in claim 34, further comprising computer executable instructions that, when executed, direct the client device to display the schedule information in a first section of the program grid before a current time, and direct the client device to display the schedule information in a second section of the program grid after the current time.

37. One or more computer-readable media as recited in claim 34, further comprising computer executable instructions that, when executed, direct the client device to:
display a time of day in a first section of the program grid to indicate when a program will be broadcast for viewing;
display a program channel in the first section of the program grid to indicate over which channel the program will be broadcast for viewing; and
display the time of day and the program channel in a second section of the program grid after the program has been broadcast for viewing.
